(19) United States
(12) Patent Application Publication
(10) Pub. No.: US 2018/0157142 A1
(43) Pub. Date: Jun. 7, 2018

(54) ELECTROPHORESIS APPARATUS AND ELECTRONIC EQUIPMENT

(71) Applicant: SEIKO EPSON CORPORATION, Tokyo (JP)

(72) Inventor: Takashi MIYATA, Shiojiri-shi (JP)

(73) Assignee: SEIKO EPSON CORPORATION, Tokyo (JP)

(21) Appl. No.: 15/829,383

(22) Filed: Dec. 1, 2017

(30) Foreign Application Priority Data
Dec. 7, 2016 (JP) 2016-237426

(51) Int. Cl. G02F 1/167; G09G 3/34; G02F 1/1362

(52) U.S. Cl. CPC G02F 1/167; G09G 3/344; G02F 1/136286; G09G 2310/0213; G02F 1/1368; G09G 2310/0283; G09G 2320/0271; G02F 2001/1676; G02F 2001/1672; G09G 2300/0426

(57) ABSTRACT

An electrophoresis apparatus includes: a first substrate that includes an electrode; a second substrate that includes a wiring line; a partition wall portion that is provided between the first substrate and the second substrate; and a conducting portion for electric conduction between the electrode and the wiring line, the conducting portion including a base portion and a conductive coating portion, the base portion being covered by the conductive coating portion, wherein the base portion is made of the same material as a material of the partition wall portion.

### BACKGROUND

### 1. Technical Field

The present invention relates to a technique for displaying an image by utilizing dispersion liquid that contains charged particles dispersed in a medium (hereinafter referred to as “electrophoresis dispersion liquid”).

### 2. Related Art

For example, in a display device disclosed in JP-A-2009-229911, electrophoresis dispersion liquid is held at a gap between a transparent substrate and an element substrate facing the transparent substrate. A common electrode is formed on the inner surface of the transparent substrate. The common electrode is electrically connected to a wiring line provided over the element substrate via vertical electric conductors formed at some corners of the transparent substrate.

In the technique disclosed in JP-A-2009-229911, the vertical electric conductors are formed through an independent process that is different from the processes of forming other components at the gap between the transparent substrate and the element substrate. Therefore, the manufacturing of an electrophoresis apparatus having such a structure is complex.

### SUMMARY

An advantage of some aspects and preferred modes of the invention is that the manufacturing of an electrophoresis apparatus is simplified.

An electrophoresis apparatus according to an aspect of the invention includes: a first substrate; a second substrate; a partition wall portion provided between the first substrate and the second substrate; an electrode provided on the first substrate; and a conducting portion for electric conduction between the electrode and a wiring line provided over the second substrate, wherein the conducting portion includes a base portion and a conductive coating portion, wherein the base portion is made of the same material as a material of the partition wall portion and rises toward the first substrate, and wherein the base portion is covered by the conductive coating portion. In the above structure, the base portion of the conducting portion for electric conduction between the electrode and the wiring line provided over the second substrate is made of the same material as that of the partition wall portion provided between the first substrate and the second substrate. Therefore, it is possible to simplify the manufacturing of the electrophoresis apparatus, as compared with a case where the base portion is formed using a material different from the material of the partition wall portion through a process different from the process of the partition wall portion. As another advantage, it is possible to reduce the resistance between the electrode and the wiring line, as compared with a structure of using a conductive paste or conductive balls for electric conduction between the electrode and the wiring line provided over the second substrate.

In an electrophoresis apparatus according to a preferred mode, as the conducting portion mentioned above, a plurality of conductors is provided. Since a plurality of conductors is provided in the preferred mode, as compared with a structure in which a single conductor only is provided, the effect of reducing the resistance between the electrode and the wiring line provided over the second substrate is remarkable.

In an electrophoresis apparatus according to a preferred mode, the conductors are arranged alongside a pixel area where electrophoresis dispersion liquid is provided. In the preferred mode, a wide region of the electrode is electrically connected to the wiring line provided over the second substrate. Therefore, advantageously, it is possible to reduce voltage differences in the plane of the electrode.

An electrophoresis apparatus according to a preferred mode further includes a drive circuit that activates charged particles, wherein the conductors are arranged alongside the drive circuit. In the preferred mode, a wide region of the electrode is electrically connected to the wiring line provided over the second substrate. Therefore, advantageously, it is possible to reduce voltage differences in the plane of the electrode.

In an electrophoresis apparatus according to a preferred mode, the conductive coating portion is formed in such a way as to overlie a ground surface on which the base portion is formed in addition to covering the base portion. In the preferred mode, not only the base portion but also the ground under the base portion is covered by the conductive coating portion. Therefore, as compared with a structure in which the base portion only is covered by the conductive coating portion, the effect of reducing the resistance between the electrode and the wiring line provided over the second substrate is remarkable.

An electronic device according to an aspect of the invention includes the electrophoresis apparatus according to the above aspect or the above preferred mode. Preferred examples of the electronic device are a watch and electronic paper. However, the scope of the invention is not limited to these examples.

In a method of manufacturing an electrophoresis apparatus according to an aspect of the invention, the electrophoresis apparatus includes: a first substrate and a second substrate that hold therebetween electrophoresis dispersion liquid containing charged particles and a dispersion medium; a partition wall portion provided between the first substrate and the second substrate to compartmentalize the gap therebetween; an electrode provided on the first substrate; and a conducting portion for electric conduction between the electrode and a wiring line provided over the second substrate, wherein the conducting portion includes a base portion and a conductive coating portion, wherein the base portion is provided over the surface of the second substrate and rises toward the first substrate, wherein the base portion is covered by the conductive coating portion, and wherein the base portion is made of the same material as a material of the partition wall portion. In the above method, the base portion of the conducting portion for electric conduction between the electrode and the wiring line provided over the second substrate is made of the same material as that of the partition wall portion provided between the first substrate and the second substrate. Therefore, it is possible to simplify the manufacturing of the electrophoresis apparatus, as compared with a case where the base portion is formed using a material different from the material of the partition wall portion through a process different from the process of the partition wall portion.

### BRIEF DESCRIPTION OF THE DRAWINGS

The invention will be described with reference to the accompanying drawings, wherein like numbers reference like elements.

FIG. 1 is a plan view of an electrophoresis apparatus according to a first embodiment of the invention.

FIG. 2 is a cross-sectional view of the electrophoresis apparatus.

FIG. 3 is a plan view of an example of the structure of pixel electrodes and a partition wall portion.

FIG. 4 is a plan view of an example of the structure of a conductive electrode and conductors.

FIG. 5 is a diagram for explaining a process P1 in a method of manufacturing an electrophoresis apparatus.

FIG. 6 is a diagram for explaining a process P2 in a method of manufacturing an electrophoresis apparatus.

FIG. 7 is a diagram for explaining a process P3 in a method of manufacturing an electrophoresis apparatus.

FIG. 8 is a diagram for explaining a process P4 in a method of manufacturing an electrophoresis apparatus.

FIG. 9 is a diagram for explaining a process P5 in a method of manufacturing an electrophoresis apparatus.

FIG. 10 is a cross-sectional view of an electrophoresis apparatus according to a second embodiment.

FIG. 11 is a plan view of an electrophoresis apparatus according to a variation example (first mode).

FIG. 12 is a plan view of an electrophoresis apparatus according to a variation example (second mode).

FIG. 13 is a plan view of an electrophoresis apparatus according to a variation example (third mode).

FIG. 14 is a plan view of an electrophoresis apparatus according to a variation example (fourth mode).

FIG. 15 is a plan view of an electrophoresis apparatus according to a variation example (fifth mode).

FIG. 16 is a front view of a wristwatch that is an example of an electronic device.

FIG. 17 is a perspective view of electronic paper that is an example of an electronic device.

### DESCRIPTION OF EXEMPLARY EMBODIMENTS

### First Embodiment

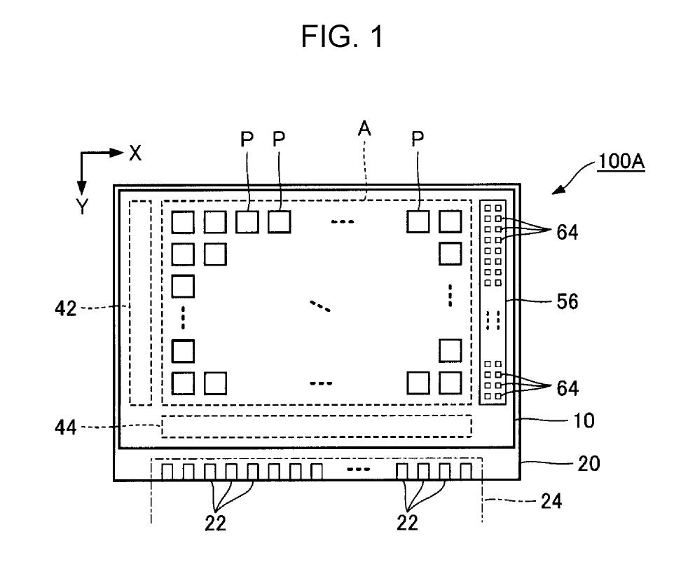

FIG. 1 is a plan view of an electrophoresis apparatus 100A according to a first embodiment of the invention. An electrophoresis apparatus 100A according to a first embodiment is a display device that displays an image by using a plurality of pixels P arranged in X and Y directions orthogonal to each other in a matrix of rows and columns inside a pixel area A. As illustrated in FIG. 1, which shows an example, the electrophoresis apparatus 100A includes a first substrate 10 and a second substrate 20 facing each other, with a clearance therebetween. The first substrate 10 is disposed at a user-side position, which is closer to a user who views a displayed image. The second substrate 20 is disposed at an opposite (rear) position, which is not closer to the user. Each of the first substrate 10 and the second substrate 20 is a plate member that allows light to pass through itself. However, the light transmissivity of the second substrate 20, which is the rear substrate, is not indispensable.

As illustrated in FIG. 1, the second substrate 20 has an area extending beyond an edge of the first substrate 10 (hereinafter referred to as “mount area”). A plurality of connection terminals 22 is provided on the mount area. Each of the plurality of connection terminals 22 is electrically connected to an external apparatus through a wiring substrate (for example, flexible cable) 24 connected to the mount area.

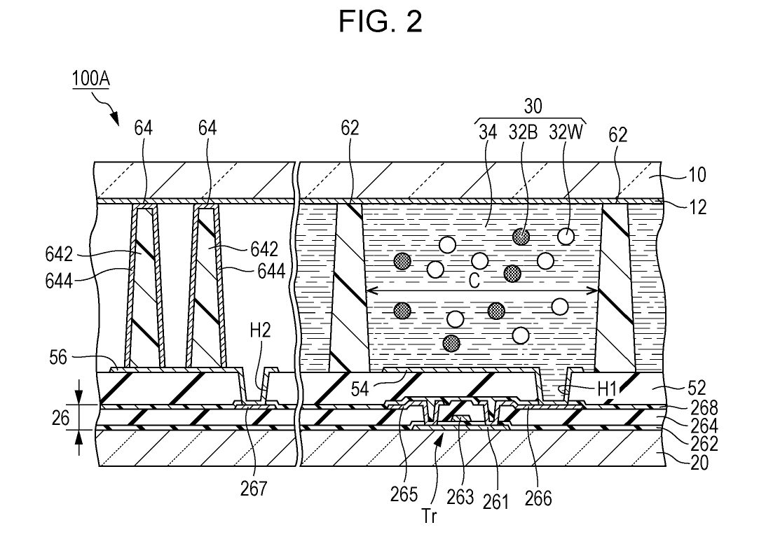

FIG. 2 is a cross-sectional view of the electrophoresis apparatus 100A. As illustrated in FIG. 2, which shows an example, electrophoresis dispersion liquid 30 is held at the gap between the first substrate 10 and the second substrate 20. The electrophoresis dispersion liquid 30 is a display medium for performing gradation display by utilizing the electrophoretic migration of a plurality of charged particles 32 (32B, 32W). Specifically, the electrophoresis dispersion liquid 30 includes white charged particles 32W, black charged particles 32B, and a dispersion medium 34, in which the plurality of charged particles 32 (32B, 32W) is dispersed in such a way as to be able to migrate electrophoretically, wherein the white charged particles 32W and the black charged particles 32B are charged to respective polarities that are the opposite of each other.

As illustrated in FIG. 2, a common electrode 12 is provided on the facing surface of the first substrate 10, that is, the surface oriented to the second substrate 20. The common electrode 12 is a plane electrode that is continuous over the plurality of pixels P arranged inside the pixel area A. The common electrode 12 is made of a light-transmissive conductive material such as, for example, ITO (Indium Tin Oxide) or IZO (Indium Zinc Oxide). The common electrode 12 of the first embodiment extends throughout the entire surface of the first substrate 10 (both inside and outside the pixel area A).

As illustrated in FIG. 2, a circuit layer 26 is provided on the facing surface of the second substrate 20, that is, the surface oriented to the first substrate 10. The circuit layer 26 is made up of a plurality of layers the top one of which is a protective layer (passivation layer) 268. The circuit layer 26 includes a plurality of transistors and a plurality of wiring lines.

The plurality of wiring lines in the circuit layer 26 includes, for example, a plurality of scanning lines extending in the X direction and a plurality of signal lines extending in the Y direction. A pixel P is provided at a position corresponding to each of the intersections of the scanning lines and the signal lines. The plurality of transistors constitutes, for example, a plurality of pixel circuits in addition to a scanning line drive circuit (Y driver) and a signal line drive circuit (X driver). For sequential selection of the plurality of scanning lines, the scanning line drive circuit supplies a scanning signal to the plurality of scanning lines one after another. The signal line drive circuit supplies a gradation signal corresponding to a gradation specified for each pixel P to each of the plurality of signal lines. As illustrated in FIG. 1, a scanning line drive circuit 42 and a signal line drive circuit 44 are provided outside the pixel area A. Specifically, the scanning line drive circuit 42 is provided along a Y-extending edge located at the negative-X directional side of the first substrate 10, and the signal line drive circuit 44 is provided along an X-extending edge located at the positive-Y directional side of the first substrate 10. The pixel circuit (not illustrated) is a circuit for controlling the gradation of the pixel P. For each of the plurality of pixels P, the corresponding pixel circuit is provided inside the pixel area A.

As illustrated in FIG. 2, each of a plurality of transistors Tr in the circuit layer 26 includes a semiconductor layer 261, a gate electrode 263, a source electrode 265, and a drain electrode 266. The semiconductor layer 261 is made of a semiconductor material such as, for example, polysilicon, and is formed on the surface of the second substrate 20. The gate electrode 263 is made of a conductive material such as, for example, molybdenum (Mo). The gate electrode 263 is located over the channel region of the semiconductor layer 261. A gate insulation layer 262 is sandwiched between the semiconductor layer 261 and the gate electrode 263. The semiconductor layer 261 and the gate electrode 263 are covered by an interlayer insulation layer 264 illustrated in FIG. 2. The source electrode 265 and the drain electrode 266 are formed on the surface of the interlayer insulation layer 264. The source electrode 265 and the drain electrode 266 are connected to the semiconductor layer 261 via conduction holes (contact holes) formed through the interlayer insulation layer 264 and the gate insulation layer 262. In addition, a plurality of wiring lines is formed on the surface of the interlayer insulation layer 264. For example, as illustrated in FIG. 2, a wiring line 267 for connecting the common electrode 12 on the first substrate 10 to the plurality of connection terminals 22 on the second substrate 20 is formed on the surface of the interlayer insulation layer 264. The plurality of transistors Tr and the plurality of wiring lines are covered by the protective layer 268, which is the top one of the plurality of layers making up the circuit layer 26.

An insulation layer 52 is formed on the surface of the circuit layer 26. The insulation layer 52 is a flattening coating for eliminating the level difference in the surface of the circuit layer 26 (so-called planarizing layer). The insulation layer 52 is made of a light-transmissive resin material such as, for example, an acryl resin material or an epoxy resin material. The film thickness of the insulation layer 52 is, for example, approximately 3 m.

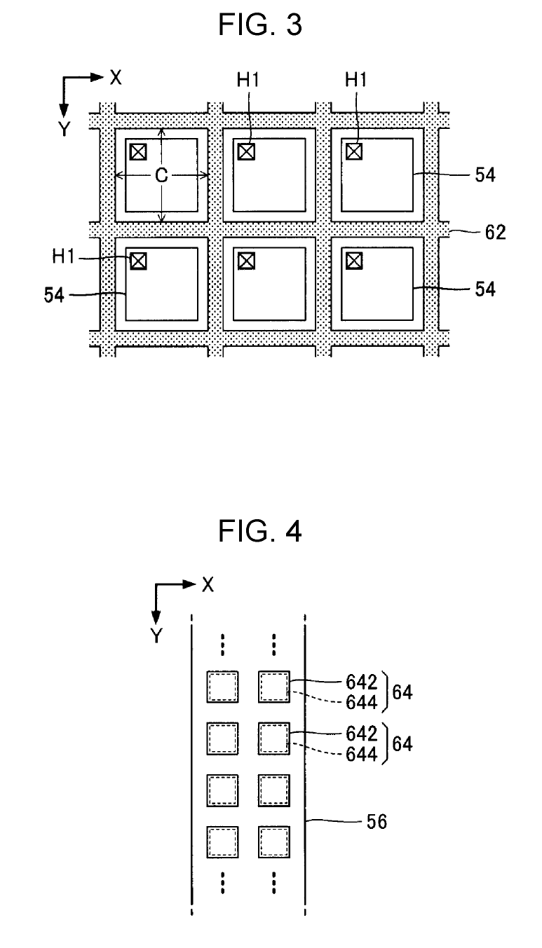

As illustrated in FIG. 2, a plurality of pixel electrodes 54 and a conductive electrode 56 are formed on the surface of the insulation layer 52. Each of the plurality of pixel electrodes 54, and the conductive electrode 56, is made of a light-transmissive conductive material such as, for example, ITO or IZO. Each of the plurality of pixel electrodes 54 is an individual electrode that is shaped like a rectangle and is formed for the corresponding one of the plurality of pixels P. The pixel electrode 54 is electrically connected to the transistor Tr (for example, the drain electrode 266) of the pixel circuit via the conduction hole H1 formed through the insulation layer 52 and the protective layer 268. As illustrated in FIG. 3, which shows an example, the pixel electrodes 54 are arranged in the X and Y directions in a matrix of rows and columns inside the pixel area A and are spaced apart from one another.

Gradation (white/black) is controlled for each of the plurality of pixel electrodes 54 by means of electrophoretic migration of the plurality of charged particles 32 between the pixel electrode 54 and the common electrode 12. For example, the approach of the white charged particles 32W to the common electrode 12 results in white display, and the approach of the black charged particles 32B to the common electrode 12 results in black display. As will be understood from the above description, the region where pixel electrode 54 and the common electrode 12 face each other, with the electrophoresis dispersion liquid 30 held therebetween, functions as the pixel P.

The conductive electrode 56 illustrated in FIG. 2 is an electrode for electrically connecting the common electrode 12 on the first substrate 10 to the aforementioned wiring line 267 (and further to the plurality of connection terminals 22 on the second substrate 20). The conductive electrode 56 is located outside the pixel area A. Therefore, the conductive electrode 56 faces, of the common electrode 12, a region located outside the pixel area A. As illustrated in FIG. 1, the conductive electrode 56 of the first embodiment is an elongated electrode that is provided along a Y-extending edge located at the positive-X directional side (that is, the opposite side in relation to the scanning line drive circuit 42) of the second substrate 20. As illustrated in FIG. 2, the conductive electrode 56 is connected to the wiring line 267 via a conduction hole H2 formed through the insulation layer 52 and the protective layer 268. Though a single conduction hole H2 is shown in FIG. 2, the conductive electrode 56 may be connected to the wiring 267 via a plurality of conduction holes H2.

As illustrated in FIG. 2, there is a partition wall portion 62 between the first substrate 10 and the second substrate 20. The partition wall portion 62 is formed over the surface of the second substrate 20 (more specifically, on the surface of the insulation layer 52). Specifically, the partition wall portion 62 is a structural member that is located inside the pixel area A and compartmentalizes the gap between the first substrate 10 and the second substrate 20 into a plurality of spaces (hereinafter referred to as “cells”) C. The top surface of the partition wall portion 62 is in contact with the common electrode 12 on the first substrate 10. In the first embodiment, as illustrated in FIG. 3, the gap between the first substrate 10 and the second substrate 20 is compartmentalized into the plurality of pixels P by the partition wall portion 62, and the cells C are arranged in the X and Y directions in a matrix of rows and columns. That is, the two-dimensional shape of the partition wall portion 62 is a grid that can be defined as a combination of line segments each extending in the X direction inside an interval region between arbitrary two pixel electrodes 54 arranged next to each other in the Y direction and line segments each extending in the Y direction inside an interval region between arbitrary two pixel electrodes 54 arranged next to each other in the X direction. The material of the partition wall portion 62 is not specifically limited. A preferred example is an acryl resin material or an epoxy resin material. As illustrated in FIG. 2, each of the plurality of cells C compartmentalized by the partition wall portion 62 is filled with the electrophoresis dispersion liquid 30. Since the partition wall portion 62 is formed inside the pixel area A, there is no electrophoresis dispersion liquid 30 outside the pixel area A. That is, the pixel area A can be paraphrased as an area where the electrophoresis dispersion liquid 30 is provided (display area). If the partition wall portion 62 is made of a light-shielding material, it is possible to use the partition wall portion 62 as a light-shielding layer that blocks light at regions between the pixels P.

As illustrated in FIG. 2, there are plural conductors 64 between the first substrate 10 and the second substrate 20. The plurality of conductors 64 is formed over the surface of the second substrate 20 (more specifically, on the surface of the conductive electrode 56). The plurality of conductors 64 serves as a structural member for electrically connecting the common electrode 12 on the first substrate 10 to the wiring line 267 over the second substrate 20 (for so-called vertical electric conduction). The plurality of conductors 64 is located outside the pixel area A. As illustrated in FIG. 4, which shows an example, and in FIG. 2, the plural conductors 64 are formed on the surface of the conductive electrode 56 and are spaced apart from one another. Specifically, for example, the plural conductors 64 are arranged in the X and Y directions in such a way as to form a plurality of columns (in a matrix of rows and columns). As can be seen from FIG. 1, the plurality of conductors 64 of the first embodiment is formed alongside the pixel area A. Specifically, the plural conductors 64 are arranged alongside the pixel area A in parallel with a Y-extending border located at the positive-X directional side of the pixel area A. The array pattern of the plural conductors 64 may be modified arbitrarily. For example, the plural conductors 64 may be arranged in a line in the Y direction.

As illustrated in FIG. 2, each of the plurality of conductors 64 includes a base portion 642 and a conductive coating portion 644. The base portion 642 is a pillar portion that is provided upright on the surface of the conductive electrode 56 and rises in a protruding manner from the surface toward the first substrate 10. As illustrated in FIGS. 2 and 4, the base portion 642 of the first embodiment has a shape of a horizontally-truncated n-polygonal pyramid that is polygonal in cross section and has a diminishing width that decreases toward the first substrate 10 (for example, a horizontally-truncated quadrangular pyramid). However, the three-dimensional shape of the base portion 642 is not limited to this example. For example, the base portion 642 may have a shape of a horizontally-truncated cone that is circular in cross section. Alternatively, the base portion 642 may have a shape of a cylinder or a prism, the width of which does not change from the bottom end to the top end.

The base portion 642 and the partition wall portion 62 are made of the same material and constitute the same layer. Specifically, the base portion 642 and the partition wall portion 62 are formed together in the same process as a result of the selective removal (patterning) of an insulation layer covering the entire area of the second substrate 20. Therefore, a common material is used for forming the base portion 642 and the partition wall portion 62. For example, as mentioned earlier regarding the material of the partition wall portion 62, the base portion 642 is also made of, as a preferred example, an epoxy resin material or an acryl resin material. The height of the base portion 642 is approximately equal to the height of the partition wall portion 62 (for example, 20 μm or greater).

The conductive coating portion 644 is a coat with which the base portion 642 is covered. As its name suggests, the conductive coating portion 644 is made of a conductive material. The conductive material used for forming the conductive coating portion 644 is not specifically limited. A preferred example is a low-resistance metal material such as aluminum or silver. As illustrated in FIG. 2, the top (head surface) and sides of the base portion 642 are covered by the conductive coating portion 644. Specifically, the top of the base portion 642 is covered by a part of the conductive coating portion 644, and the surface of this part is in contact with, of the common electrode 12, the aforementioned region located outside the pixel area A. The bottom end of the conductive coating portion 644 around the bottom of the base portion 642 is in contact with the surface of the conductive electrode 56. Therefore, the common electrode 12 is electrically connected to the conductive electrode 56 via the conductive coating portion 644 of each of the plurality of conductors 64. That is, the common electrode 12 is electrically connected to the connection terminals 22 via the conductors 64 each having the conductive coating portion 644, and then via the conductive electrode 56 and the wiring line 267. Because of the electric connection between the common electrode 12 and the connection terminals 22, a predetermined voltage supplied from an external apparatus to the connection terminals 22 via the wiring substrate 24 is applied to the common electrode 12.

### Method of Manufacturing Electrophoresis Apparatus 100A

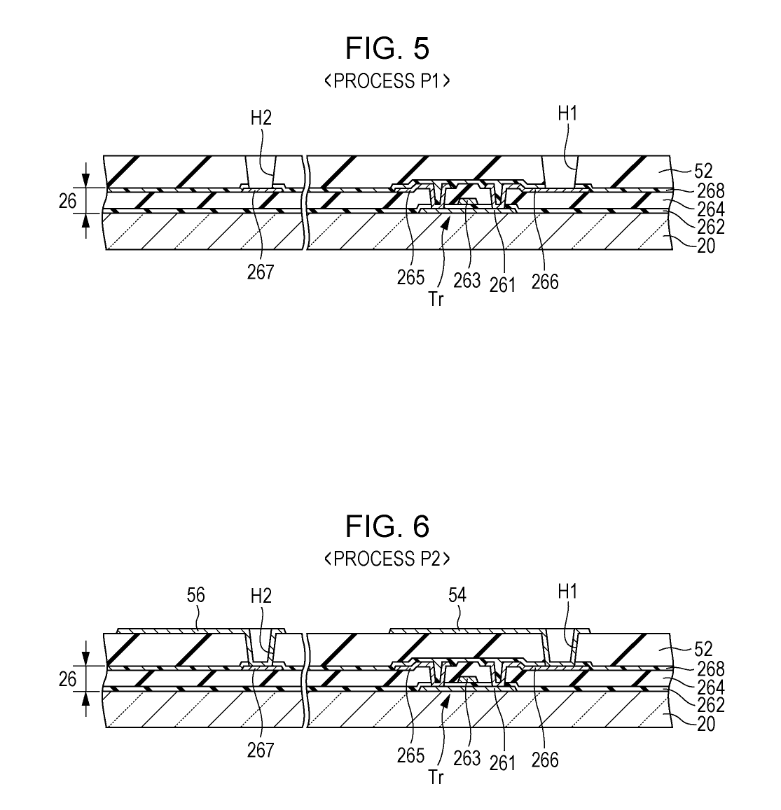

Next, a method of manufacturing the electrophoresis apparatus 100A, examples of which are described above, will now be explained. FIGS. 5 to 9 are step-by-step production diagrams each illustrating, as an example, a process of a method of manufacturing the electrophoresis apparatus 100A. As illustrated in FIG. 5, in a process P1, a second substrate 20 on which a circuit layer 26 and an insulation layer 52 are provided in layers is prepared. Of the insulation layer 52, the region located inside the pixel area A has respective conduction holes H1 for the plurality of pixels P. Of the insulation layer 52, the region located outside the pixel area A has a conduction hole(s) H2. Any known manufacturing technique can be employed for forming the circuit layer 26 and the insulation layer 52.

After the execution of the process P1, in a process P2, as illustrated in FIG. 6, a plurality of pixel electrodes 54 is formed inside the pixel area A, and a conductive electrode 56 is formed outside the pixel area A. Specifically, for example, a conductive film is formed in such a manner that the entire surface of the insulation layer 52 becomes covered by the conductive film. Then, the conductive film is selectively removed so as to form the plurality of pixel electrodes 54 and the conductive electrode 56 together. A film deposition technique such as, for example, sputtering can be suitably used for forming the conductive film. For the selective removal of the conductive film, for example, photolithography or etching can be suitably used.

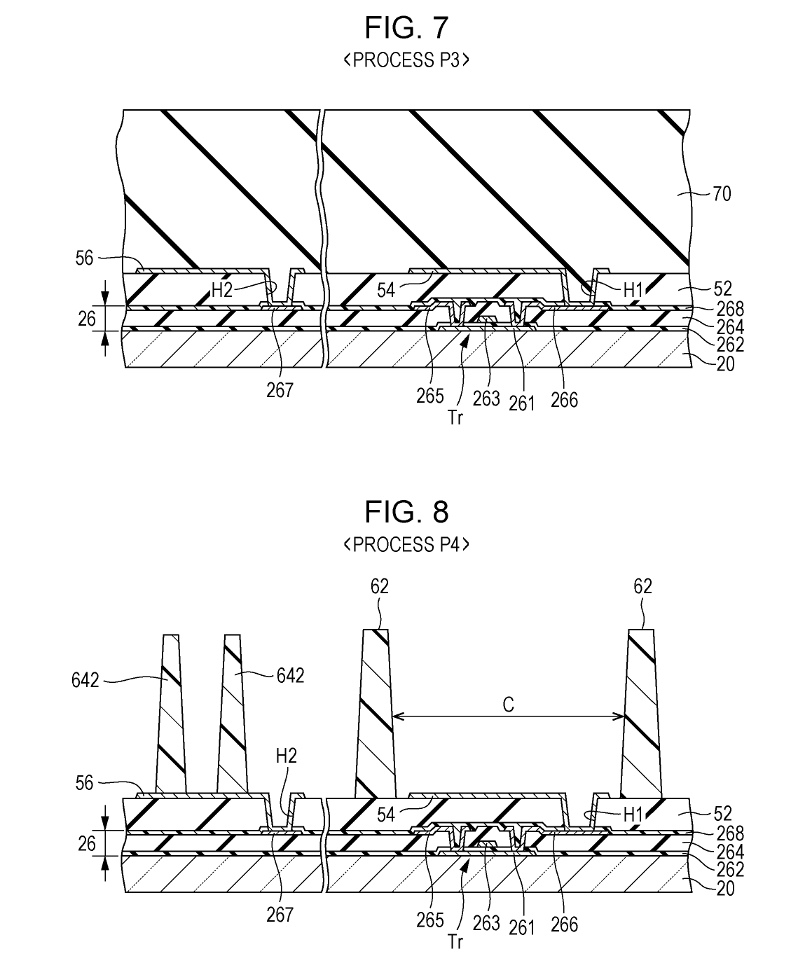

After the execution of the process P2, in a process P3, as illustrated in FIG. 7, an insulation layer 70 is formed in such a manner that the entire surface of the insulation layer 52 having the plurality of pixel electrodes 54 and the conductive electrode 56 becomes covered by the insulation film 70. A film deposition technique such as, for example, spin coating can be used for forming the insulation layer 70. The material of the insulation film 70 is, for example, an acryl resin material or an epoxy resin material. The viscosity of the insulation layer 70 before curing is, for example, 2,000 mPa/s, which is considerably higher than the viscosity of the insulation layer 52 before curing (for example, 15 mPa/s). The hardness of the insulation layer 70 after curing, for example, approx. 2 GPa, is greater than the hardness of the insulation layer 52 after curing (for example, 0.5 GPa).

After the execution of the process P3, in a process P4, as illustrated in FIG. 8, a base portion 642 of each of a plurality of conductors (hereinafter may be referred to as “the plurality of bases 642”) is formed together with a partition wall portion 62 from the common insulation layer 70. That is, the partition wall portion 62 and the plurality of bases 642 are formed together using the same material as a result of the selective removal of the insulation layer 70. A known treatment technique such as photolithography, etching, or the like can be used for the selective removal of the insulation layer 70.

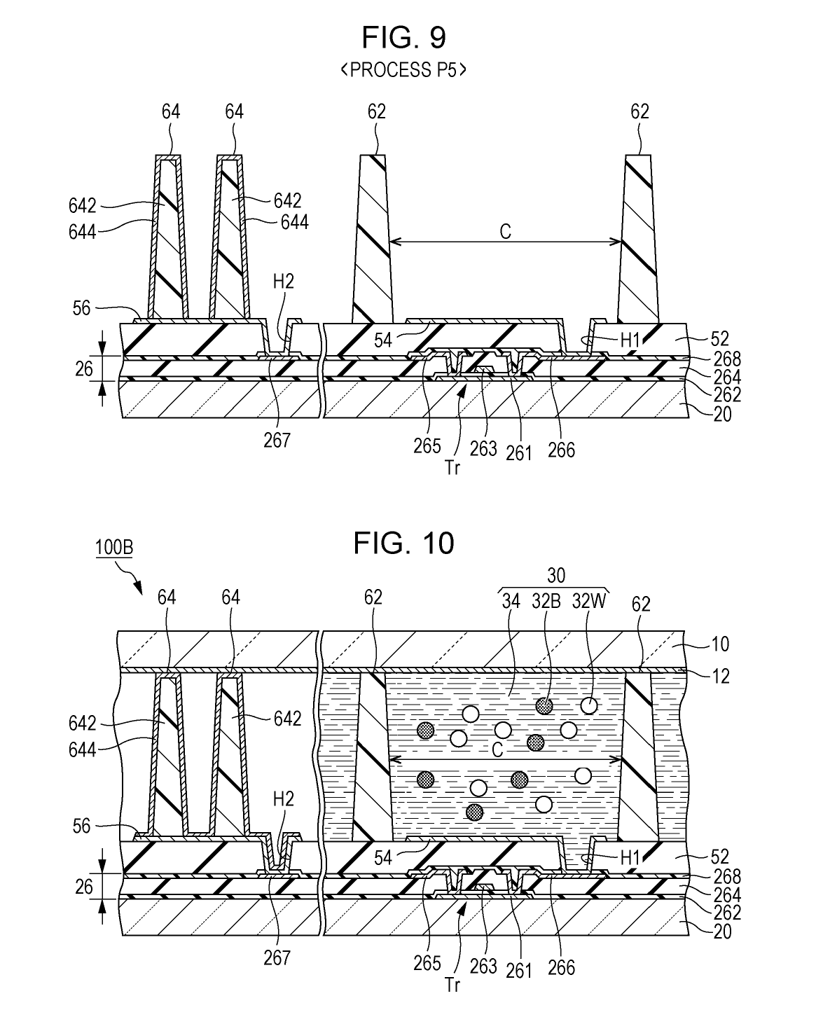

After the execution of the process P4, in a process P5, as illustrated in FIG. 9, a conductive coating portion 644 is formed on each of the plurality of bases 642. Specifically, the conductive coating portion 644 on each of the plurality of bases 642 is formed by, for example, first, forming a conductive film covering the entire area of the second substrate 20 by means of a film deposition technique such as sputtering or the like, and next by selectively removing the conductive film by means of a treatment technique such as photolithography, etching, or the like. A plurality of conductors 64 is formed as a result of the execution of the processes P4 and P5 described above.

After the execution of the process P5, a liquid filling process is executed to fill each of a plurality of cells C compartmentalized by the partition wall portion 62 with electrophoresis dispersion liquid 30. A first substrate 10 on which a common electrode 12 is provided is prepared through a different process separately from the foregoing processes of the second substrate 20. Then, the first substrate 10 and the second substrate 20 are bonded to each other, for example, with a resin sealant interposed therebetween. As a result of the bonding of the first substrate 10 and the second substrate 20 to each other, as described earlier with reference to FIG. 2, the conductive coating portion 644 of each of the plurality of conductors 64 over the second substrate 20 is disposed in contact with the common electrode 12 on the first substrate 10. That is, the common electrode 12 is electrically connected to the connection terminals 22 via the conductors 64, the conductive electrode 56, and the wiring line 267. The foregoing is a preferred example of a method of manufacturing the electrophoresis apparatus 100A.

As explained above, in the first embodiment, the base portion 642 of each of the plurality of conductors 64 connected electrically to the common electrode 12 is made of the same material as the material of the partition wall portion 62 provided between the first substrate 10 and the second substrate 20. Therefore, it is possible to simplify the manufacturing of the electrophoresis apparatus 100A, as compared with a case where the base portion 642 is formed using a material different from the material of the partition wall portion 62 through a process different from the process of the partition wall portion 62.

For electric conduction between the common electrode 12 and the conductive electrode 56, for example, an alternative structure of using a conductive paste or conductive balls provided between the first substrate 10 and the second substrate 20 is conceivable (hereinafter referred to as Comparative Example). However, in Comparative Example, it is difficult to ensure sufficient area size for contact of the conductive paste or the conductive balls with the common electrode 12. For this reason, it is practically difficult to achieve a satisfactory reduction in resistance between the common electrode 12 and the wiring line 267. For example, for a liquid crystal device, electric conduction by means of a conductive paste or conductive balls is sufficient because a voltage applied to a liquid crystal element is several volts, whereas a high voltage of 10 V or so is applied between the pixel electrodes 54 and the common electrode 12 in the electrophoresis apparatus 100A. Therefore, for the electrophoresis apparatus 100A, it is very important to reduce the resistance between the common electrode 12 and the wiring line 267.

In the first embodiment, electric conduction between the common electrode 12 and the conductive electrode 56 is provided by utilizing the plurality of conductors 64, each of which is a pillar portion rising from the electrode surface over the second substrate 20 toward the first substrate 10. Such a structure of the first embodiment ensures sufficient contact area of the conductors 64 (the conductive coating portion 644) and the conductive electrode 56 and sufficient contact area of the conductors 64 (the conductive coating portion 644) and the common electrode 12. Therefore, it is possible to reduce the resistance between the common electrode 12 and the wiring line 267 reliably and sufficiently. With the structure described above, even under conditions of application of a high voltage of 10 V or so between the pixel electrodes 54 and the common electrode 12, it is possible to reduce the resistance between the common electrode 12 and the wiring line 267 enough for practical use. Another advantage is a reduction in area size outside the pixel area A (realization of a so-called narrow frame structure) because of a reduction in area size that is necessary for electric conduction between the common electrode 12 and the wiring line 267.

Since the plurality of conductors 64 is provided in the first embodiment, the effect of reducing the resistance between the common electrode 12 on the first substrate 10 and the wiring line 267 over the second substrate 20 is far greater than the effect produced in a case where a single conductor 64 only is provided. Since the plurality of conductors 64 is formed alongside the pixel area A in the first embodiment, in comparison with a case where the plurality of conductors 64 is formed locally, it is possible to electrically connect a wide region of the common electrode 12 to the wiring line 267. Therefore, advantageously, it is possible to reduce voltage differences (differences in the degree of voltage drop) in the plane of the common electrode 12.

### Second Embodiment

Next, a second embodiment of the invention will now be explained. In each exemplary structure described below, the same reference numerals as those used in the description of the first embodiment above are assigned to elements that are the same as, or similar to, those of the first embodiment in terms of operation or function, to omit a detailed explanation.

FIG. 10 is a cross-sectional view of an electrophoresis apparatus 100B according to a second embodiment. In the first embodiment, a structure example in which the top and sides of the base portion 642 are covered by the conductive coating portion 64 is disclosed. In the conductor 64 according to the second embodiment, as illustrated in FIG. 10, which shows an example, the conductive coating portion 644 is formed in such a way as to overlie a ground surface on which the base portion 642 is formed (specifically, the surface of the conductive electrode 56) in addition to covering the top and sides of the base portion 642. Specifically, the contour shape of the conductive coating portion 644 formed as described herein in plan view is the same as the contour shape of the conductive electrode 56 in plan view. That is, the conductive coating portion 644 of the second embodiment is continuous across the plurality of bases 642 formed on the surface of the conductive electrode 56.

The second embodiment produces the same effects as those of the first embodiment. Moreover, since the conductive coating portion 644 is formed in such a way as to cover both the base portion 642 and the ground under the base portion 642, the second embodiment produces a remarkable effect of reducing the resistance between the common electrode 12 and the conductive electrode 56. Variation Examples

The embodiments described as examples above can be modified in various ways. Some specific examples of variation are described below. The variation examples described below can be applied to the foregoing embodiments. Moreover, any two or more selected from among the variation examples described below may be combined as long as they are not contradictory to each other or one another.

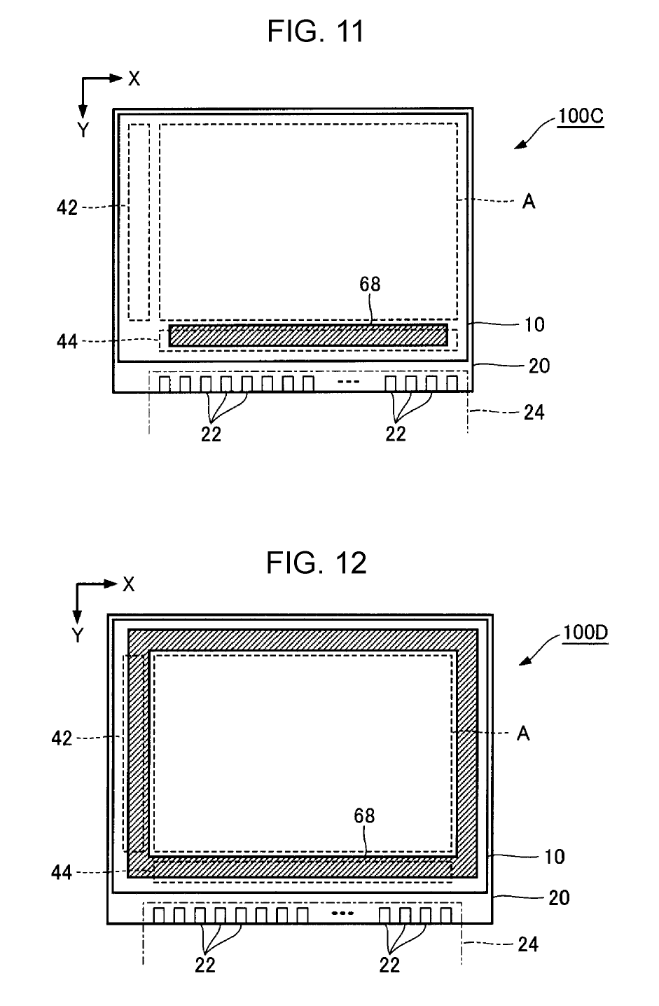

(1) The positional relationship among the pixel area A, the plurality of conductors 64, and the drive circuit (the scanning line drive circuit 42 or the signal line drive circuit 44) is not limited to the examples in the foregoing embodiments. For example, various modes described as examples below can be adopted. In FIGS. 11 to 15 referred to in the description below, the area where the conductive electrode 56 and the plurality of conductors 64 are formed (hereinafter referred to as “electric conduction area”) is denoted with a reference numeral 68. That is, in plan view, the contour shape of the conductive electrode 56 is the same as the contour shape of the electric conduction area 68, and the plural conductors 64 are arranged inside the electric conduction area 68.

### First Mode (FIG. 11)

In an electrophoresis apparatus 100C of a first mode illustrated in FIG. 11, the electric conduction area 68 including the conductive electrode 56 and the plurality of conductors 64 overlaps with the signal line drive circuit 44 in plan view. Specifically, the electric conduction area 68 is formed alongside the pixel area A in parallel with an X-extending border located at the positive-Y directional side of the pixel area A (or alongside the signal line drive circuit 44). That is, the conductive electrode 56 is elongated in the X direction, and the plural conductors 64 are arranged in the X direction. The conductive electrode 56 and the plurality of conductors 64 may be formed in such a way as to overlap with the scanning line drive circuit 42 in plan view.

In a structure in which the plurality of conductors 64 is formed alongside a drive circuit (the scanning line drive circuit 42 or the signal line drive circuit 44), in comparison with a structure in which the plurality of conductors 64 is formed locally, it is possible to electrically connect a wide region of the common electrode 12 to the wiring line 267. Therefore, advantageously, it is possible to reduce voltage differences (differences in the degree of voltage drop) in the plane of the common electrode 12. Moreover, since the conductive electrode 56 and the plurality of conductors 64 is formed in such a way as to overlap with the drive circuit in plan view in the first mode, in comparison with a structure in which the conductive electrode 56 and the plurality of conductors 64 do not overlap with the drive circuit, it is possible to reduce the size of the electrophoresis apparatus 100C, which is another advantage.

### Second Mode (FIG. 12)

In an electrophoresis apparatus 100D of a second mode illustrated in FIG. 12, the pixel area A is completely surrounded by the frame-shaped electric conduction area 68 including the conductive electrode 56 and the plurality of conductors 64. Since the above structure electrically connects the common electrode 12 to the wiring line 267 over the second substrate 20 at the periphery entirely around the pixel area A, the effect of reducing voltage differences in the plane of the common electrode 12 is remarkable.

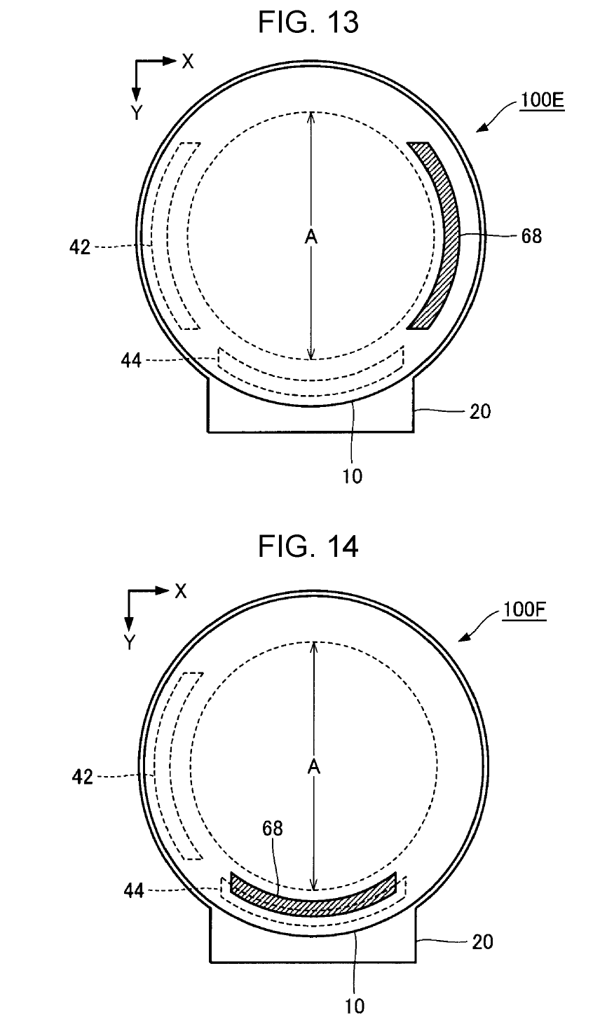

### Third Mode (FIG. 13)

An electrophoresis apparatus 100E of a third mode illustrated in FIG. 13 is a display device used for a wearable device such as, for example, a wristwatch. The schematic shape of each of the first substrate 10 and the second substrate 20 in plan view is, roughly, a circle. Therefore, the pixel area A is circular. The scanning line drive circuit 42 and the signal line drive circuit 44 are formed at respective arc-shaped areas along the curve of the circular pixel area A. In the third mode illustrated in FIG. 13, the electric conduction area 68 including the conductive electrode 56 and the plurality of conductors 64 is another arc-shaped area located outside the pixel area A, at the opposite side in relation to the scanning line drive circuit 42. That is, the conductive electrode 56 has a shape of an arc, and the plural conductors 64 are arranged in a shape of an arc.

### Fourth Mode (FIG. 14)

In an electrophoresis apparatus 100F of a fourth mode illustrated in FIG. 14, similarly to the third mode, each of the first substrate 10 and the second substrate 20 has a shape of a circle in plan view. The electric conduction area 68 of the fourth mode is an arc-shaped area that overlaps with the signal line drive circuit 44 in plan view. The electric conduction area 68 may be formed in such a way as to overlap with the scanning line drive circuit 42 in plan view. The fourth mode produces the same effects as those of the first mode described earlier.

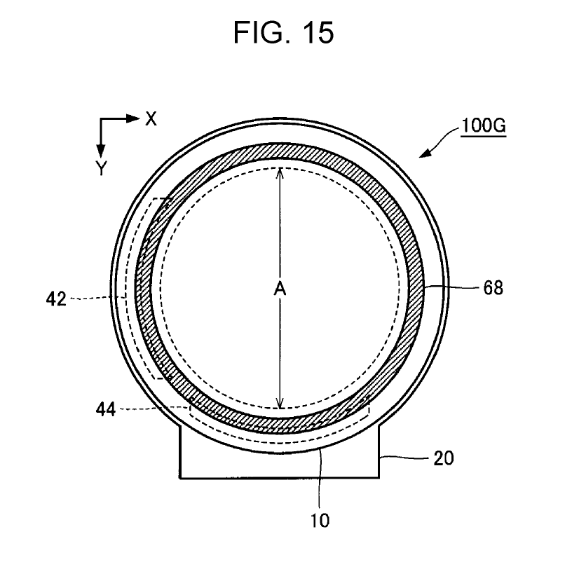

### Fifth Mode (FIG. 15)

In an electrophoresis apparatus 100G of a fifth mode illustrated in FIG. 15, similarly to the third mode, each of the first substrate 10 and the second substrate 20 has a shape of a circle in plan view. The electric conduction area 68 of the fifth mode is a ring-shaped area that completely surrounds the pixel area A. That is, the conductive electrode 56 has a shape of a ring, and the plural conductors 64 are arranged in a shape of a ring, encircling the pixel area A. The fifth mode produces the same effects as those of the second mode described earlier.

(2) In the structure of the foregoing embodiments, the partition wall portion 62 has a shape for compartmentalizing the gap between the first substrate 10 and the second substrate 20 into the plurality of pixels P. However, the shape of the partition wall portion 62 is not limited to such an example. For example, the partition wall portion 62 may have a shape for compartmentalizing the gap between the first substrate 10 and the second substrate 20 into a plurality of pixel blocks, each of which is made up of some pixels P arranged adjacent to each other or one another. It is not necessary that the partition wall portion 62 should be continuous in the area of the second substrate 20. That is, the partition wall portion 62 may be made up of plural segments that are separated from each other or one another.

(3) In the structure of the foregoing embodiments, the common electrode 12 is a plane electrode that extends throughout the entire surface of the first substrate 10. However, the shape of the common electrode 12 in plan view is not limited to such an example. For example, plural common electrodes 12 that are separated from each other or one another may be formed on the surface of the first substrate 10. In such a modified structure, similarly to the structure of the foregoing embodiments, at least one conductor 64 and wiring line 267 are formed over the surface of the second substrate 20 for each of the plurality of common electrodes 12.

(4) In the structure of the foregoing embodiments, the partition wall portion 62 and the base portion 642 are formed as a single non-stacked layer. However, the partition wall portion 62 and the base portion 642 may be formed as plural stacked layers. If the partition wall portion 62 has a multiple-layer structure, preferably, the base portion 642 should be made of the same material (and more preferably, the same layer) as that of at least one of plural layers of the partition wall portion 62. That is, “the base portion 642 and the partition wall portion 62 are made of the same material” means that, if the partition wall portion 62 has a single-layer structure, the base portion 642 is made of the same material as that of the single layer of the partition wall portion 62, and means that, if the partition wall portion 62 has a multiple-layer structure, the base portion 642 is made of the same material as that of at least one of the plural layers of the partition wall portion 62. The number of layers of the conductive coating portion 644 is also not specifically limited, that is, the conductive coating portion 644 may have a multiple-layer structure.

### Electronic Device

The electrophoresis apparatus 100 (100A, 100B, 100C, 100D, 100E, 100F, 100G), some examples of which are described above, can be applied to various kinds of electronic device. Some examples of the specific structure of an electronic device to which the electrophoresis apparatus 100 is applied are described below.

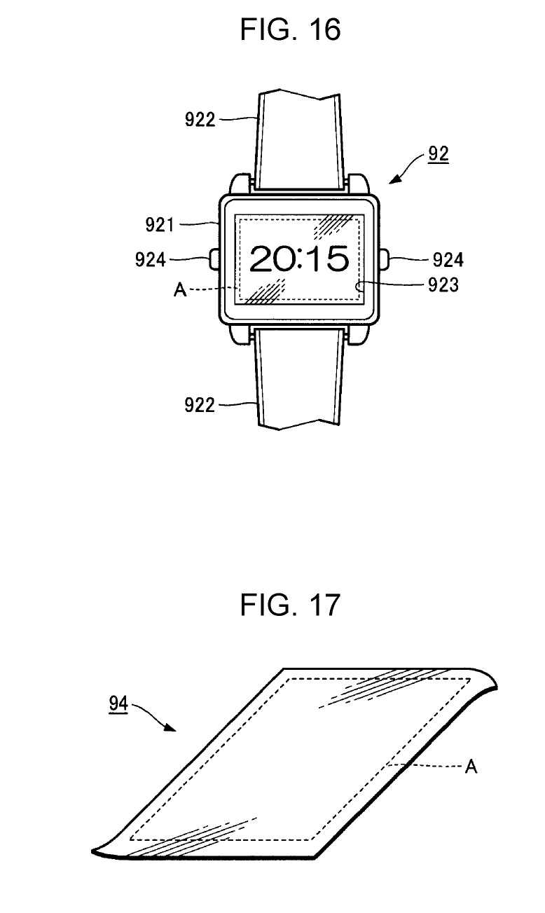

FIG. 16 is a front view of a wristwatch 92, in which the electrophoresis apparatus 100 is used as a display device. As illustrated in FIG. 16, the wristwatch 92 is a wearable device that includes a case 921, which is the housing of the electrophoresis apparatus 100, and a wristband 922, which is connected to the case 921. A user is able to wear the wristwatch 92 by wrapping the wristband 922 around the user's wrist. The pixel area A of the electrophoresis apparatus 100 is exposed through the opening 923 of the case 921 and is used for displaying various kinds of information such as time. When a crown 924 on the case 921 is operated, for example, an image displayed on the pixel area A changes.

FIG. 17 is a perspective view of electronic paper 94, another application example of the electrophoresis apparatus 100. As illustrated in FIG. 17, the electronic paper 94 includes the electrophoresis apparatus 100 in which elastic deformable sheets are used as the first substrate 10 and the second substrate 20. Various images are displayed inside the pixel area A.

Electronic devices to which aspects and modes of the invention can be applied are not limited to the above examples. An electrophoresis apparatus according to aspects and modes of the invention can be used for various kinds of electronic device, for example, an information terminal such as a mobile phone or an electronic book, etc., a portable audio player, a display device with a touch panel, and so forth.

The entire disclosure of Japanese Patent Application No. 2016-237426, filed Dec. 7, 2016 is expressly incorporated by reference herein.

What is claimed is:

1. An electrophoresis apparatus, comprising:
a first substrate that includes an electrode;
a second substrate that includes a wiring line;
a partition wall portion that is provided between the first substrate and the second substrate; and
a conducting portion for electric conduction between the electrode and the wiring line, the conducting portion including a base portion and a conductive coating portion, the base portion being covered by the conductive coating portion,
wherein the base portion is made of the same material as a material of the partition wall portion.

2. The electrophoresis apparatus according to claim 1,
wherein, as the conducting portion, a plurality of conductors is provided.

3. The electrophoresis apparatus according to claim 2,
wherein the conductors are arranged alongside a pixel area where electrophoresis dispersion liquid is provided.

4. The electrophoresis apparatus according to claim 2, further comprising:
a drive circuit that activates charged particles,
wherein the conductors are arranged alongside the drive circuit.

5. The electrophoresis apparatus according to claim 1,
wherein the conductive coating portion is formed in such a way as to overlie a ground surface on which the base portion is formed in addition to covering the base portion.

6. An electronic device that includes the electrophoresis apparatus according to claim 1.

7. An electronic device that includes the electrophoresis apparatus according to claim 2.

8. An electronic device that includes the electrophoresis apparatus according to claim 3.

9. An electronic device that includes the electrophoresis apparatus according to claim 4.

10. An electronic device that includes the electrophoresis apparatus according to claim 5.
